(19) United States
(12) Patent Application Publication
(10) Pub. No.: US 2003/0189522 A1
(43) Pub. Date: Oct. 9, 2003

(54) Tri-band antenna

(76) Inventor: Steven Zeilinger, Carol Stream, IL (US)

Correspondence Address: MOLEX INCORPORATED, 2222 WELLINGTON COURT, LISLE, IL, 60532, US

(21) Appl. No.: 10/407,297

(22) Filed: Apr. 4, 2003

Related U.S. Application Data
(60) Provisional application No. 60/370,164, filed on Apr. 4, 2002.

(51) Int. Cl. H01Q 1/24; H01Q 13/10

(52) U.S. Cl. 343/702; 343/770

(57) ABSTRACT

A multiple frequency band antenna is capable of operating in at least three distinct preselected frequency bands. The antenna includes a planar inverted F antenna (PIFA) extending horizontally, a ground leg and feed leg integrally formed therewith and extending at an angle to the PIFA. The PIFA includes a slot formed therein that separates the PIFA into an inner base portion and outer branch portion, the outer branch portion extending from one end of the base portion extending from one end of the base portion and at least partially around a perimeter of the base portion. The antenna includes a horizontal conductive element extending from the ground leg and interposed between the PIFA and associated ground plane, and the horizontal element defines an additional, or third radiating element of the antenna, which broadens the bandwidth of the antenna.

### REFERENCE TO RELATED APPLICATIONS

This application claims priority from prior Unites States Provisional Patent Application No. 60/370,164, filed Apr. 4, 2002.

### BACKGROUND OF THE INVENTION

The present invention relates generally to planar-style antennas used for mobile telephones, and more particularly to a small size planar antenna that functions in three different frequency bands.

The use of cellular and mobile telephones has expanded greatly over the past few years. When such mobile telephones were first developed, most telephones used analog signal transmission systems and thus needed only to operate in the assigned cellular band of between 824 to 894 Megahertz which is typically known in the art as the AMPS band. The radio frequency spectrum is broken into various segments so that certain frequency bands are devoted to cellular telephone traffic, public safety communication, aeronautical communication and radio and televison, for example.

With the advent of digital signal transmission systems used in mobile telephones, other frequency bands are being utilized for communication. These bands are separated and are utilized for different communications application, for example, the go anywhere aspect of the PCS (“Personal Communication Services”) band, the GSM band that is widely used in Europe and other bands. Each of these bands offers certain advantages and it is desirable to utilize mobile telephones that operate reliably within all such bands. Important to this operation are effective antennas.

Antennas are typically tuned by way of their structure, providing different sizes of radiating elements and varying their shapes. Triple, or tri-band antennas are known in the art. One such antenna is disclose in U.S. Pat. No. 5,304,078, issued Apr. 26, 1994. This antenna takes the form of a whip antenna and utilizes a double sleeve mounted concentrically on the center conductor in order to obtain the desired multiple band operational characteristics. However, this antenna and others like it are external antennas, which are not desired by consumers. Moreover, with its double sleeve construction, it could not be reduced in size and shape to fit within the telephone housing.

A flat multiple band antenna is disclosed in U.S. Pat. No. 6,329,962, issued Dec. 11, 2001. This antenna uses a flat substrate with a series of conductive strips disposed on the substrate in the form of multiple branches. The branches are formed in either an inner or outer spiral strip, which are formed by printing the strips on the substrate. However, the printed nature of the conductive strips is not robust and may be prone to detrimental damage during assembly of mobile telephones using the antenna. Moreover, ordinary PIFA-style antennas used in current mobile telephones cannot operate across both the PCN frequency band (1710-1880 MHz) and the PCS frequency band (1850-1990 MHz)

Accordingly, it is desirable to provide a multiple band antenna for use in small, internal spaces, such as those encountered in mobile telephones and which operates in multiple frequency bands.

### SUMMARY OF THE INVENTION

It is therefore a general object of the present invention to provide a low cost multiple band antenna having a small form factor and which is capable of operating in three distinct frequency bands so as to operate in GSM900 frequency band (from 880 to 960 Megahertz), the GSM1800 frequency band (from 1710-1889 Megahertz) and the PCT-GSM 1900 frequency band (also referred to as the UMTS Band extending from 1900 to 2170 Megahertz).

Another object of the present invention is to provide an improved PIFA (planar inverted-F antenna) having an improved bandwidth that operates across both the PCN band (1710-1880 MHz) and the PCS band (1850-1990 MHz), the PIFA including a horizontal radiating element interposed between the PIFA and an associated ground plane, the horizontal radiating element being connected to either the ground pins or the feed pin of the PIFA.

Another object of the present invention is to provide a multi-frequency band antenna having a third radiating arm that improves the bandwidth of the antenna to cover the PCS/PCN frequency bands.

A further object of the present invention is to provide in one embodiment of the invention, a tri-band antenna for use with mobile telephones that is capable of operating in at least three distinct preselected frequency bands, the antenna including a planar inverted F antenna (PIFA) extending horizontally, a ground leg and feed leg integrally formed therewith and extending at an angle to the PIFA, the PIFA including a slot formed therein that separates the PIFA into an inner base portion and outer branch portion, the outer branch portion extending from one end of the base portion extending from one end of the base portion and at least partially around a perimeter of the base portion, and the antenna including a horizontal conductive element extending from the ground leg and interposed between the PIFA and associated ground plane the horizontal element defining an additional, or third radiating element of the antenna, which broadens the bandwidth of the antenna.

Yet another object of the present invention is to provide an antenna as mentioned above wherein the conductive elements such as the PIFA, ground and feed pins and the horizontal radiating element are supported on an insulative support structure that is complementary in shape to a mobile telephone housing, the insulative support defining not only a support for the antenna, but also an internal cavity underneath the support into which electronic components of the supporting device can project.

The present invention accomplishes these other objects by way of its unique and novel structure.

In one principal aspect of the present invention and as exemplified by a first embodiment of the invention, the antenna includes a PIFA having a horizontal radiating element having a slot formed therein that divides the planar radiating element into three radiating elements. These three radiating elements include an inner radiating element and an outer radiating element. The outer radiating element partially extends around the perimeter of the inner radiator or at least three sides thereof,. In accordance with its PIFA shape, the horizontal radiating element has a ground leg, or pin, and a feed leg, or pin, integrally formed therewith and which are bent transversely thereto. These ground and feed legs extend in a different and, preferably vertical plane. These two legs space the radiating element apart from and above a ground plane, typically disposed on a circuit board supported within the body of an associated electronic device. A third radiating element is provided that extends outwardly from the ground leg in a horizontal direction which is parallel to the first two radiating elements and which extends in a vertical plane.

In another important aspect of the invention and as exemplified by another embodiment, an insulative support member as an antenna support means. The support member includes a base and one or more walls formed around its perimeter in order to space the support member off of a circuit board and to define a cavity underneath the support member into which electronic components may project from the circuit board. A conductive PIFA is supported by the support member and the PIFA includes a plurality of radiating elements supported in a generally horizontal plane on the surface of the support member. A pair of leg portions that respectively provide feed and ground aspects to the radiating elements, extend downwardly along the support member sides to the circuit board of the device, where they are connected to appropriate feed and ground circuits. The feed leg communicates with a base radiating element of the PIFA, while the ground leg communicates with a branch of the PIFA that leads to another radiating element. A third radiating element extends as a branch of the PIFA around a portion of the perimeter of the base radiating element.

Other objects, features and advantages of the invention will be apparent from the following detailed description taken in connection with the accompanying drawings.

### BRIEF DESCRIPTION OF THE DRAWINGS

The invention, together with its objects and the advantages thereof, may be best understood by reference to the following description taken in conjunction with the accompanying drawings, in which like reference numerals identify like elements in the figures and in which:

FIG. 1 is a top plan view of a mobile telephone with its cover removed, illustrating the environment in which antennas of the present invention are used;

FIG. 2 is a top plan view of a first embodiment of an antenna constructed in accordance with the principles of the present invention;

FIG. 3 is a perspective view of a second embodiment of an antenna constructed in accordance with the principles of the present invention;

FIG. 4 is slight perspective view of another antenna of the invention heat-stacked in place upon an insulative support member;

FIG. 5 is visual plot of the antenna of FIG. 2, without the third radiating element, illustrating two distinct operational frequency bands; and,

FIG. 6 is a VSWR plot of the antenna of FIG. 2 illustrating the coverage over three distinct frequency bands obtained with the use of the third radiating element.

### DETAILED DESCRIPTION OF THE PREFERRED EMBODIMENTS

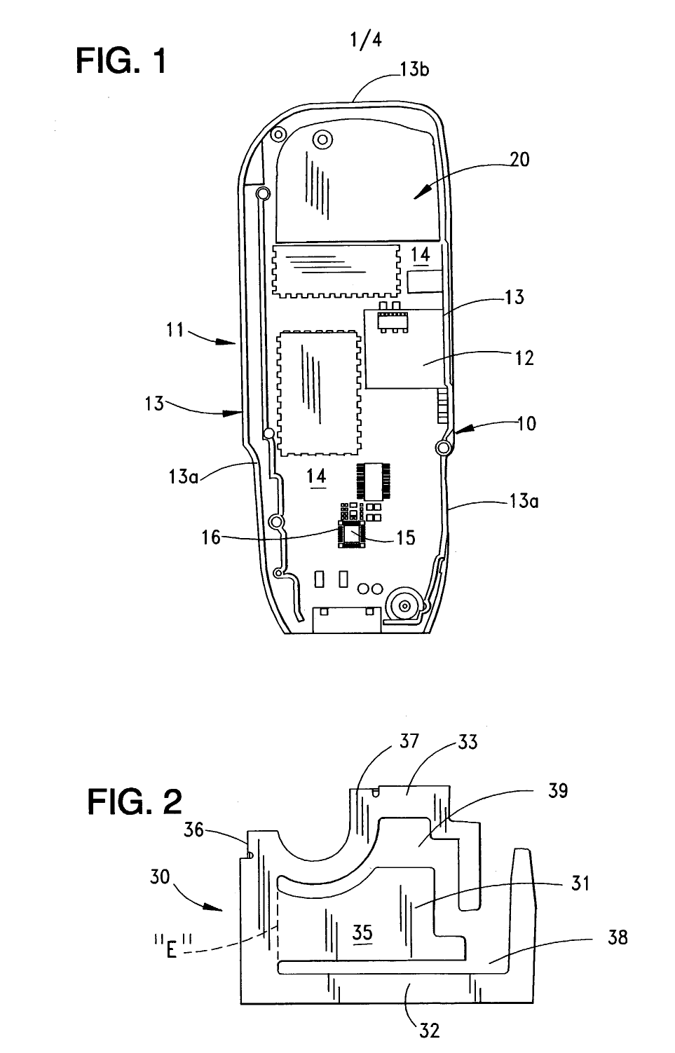

FIG. 1 illustrates a mobile telephone housing 10 which is exemplary of the environment in which antennas of the present invention are used. As is known, the telephone housing 10 is formed from suitable plastic in the form of a hollow shell 11 having an internal cavity 12 surrounded by exterior sidewalls 13a, 13b. One or more printed circuit boards 14, 20 may be provided and supported within the cavity 12. Integrated circuits 15 in the form of chips 16 that power different aspects of the telephone may be supported on the circuit boards 14 and terminated to various circuits thereon.

These style telephones may use an exterior antenna that extends from a part (not shown) formed in one of the sidewalls 13b. As mentioned above, multiple band exterior antennas are known in the art. However, these exterior multiple band antennas are large and project from the housing 10. If one were to make them retractable into the housing, they would require a long space in the housing 10 that runs alongside one of the two long sidewalls 13a. This would compromise the ability of the telephone designer and manufacturer to fill the cavity 12 with needed electronic components to provide the user with more desired communication features. Accordingly, the present invention is directed to a multiple band antenna, particularly one that operates in three different frequency bands that may be mounted within the telephone housing and which provides the desired operating performance in these three bands. One area of the telephone housing 10 that is suitable for containing an antenna is the top part of the cavity 12.

FIG. 2 illustrates a top pan view of one embodiment of multiple band antenna 30 constructed in accordance with the principles of the present invention. The antenna 30 is preferably of a PIFA style (“planar inverted-F antenna) and in that regard includes a plurality (three) of radiating elements 31, 32 & 33 that are formed from a conductive material such as sheet metal or metal foil and which can be easily stamped and formed for use above or etched onto a substrate. Other means of attaching the antenna 30, such as forming it separately and subsequently heat-stacking it to a support member, or other substrate may also be used. Although the radiating elements 31-33 are termed as “planar” in parts of this description, it will be understood that they need not be completely horizontal in the same plane and that the substrate or member that supports them may be slightly curved or crowned. In this instance, all of the radiating elements 31-33 do not entirely present a flat surface but generally do so.

As illustrated in FIG. 2, the antenna 30 includes a large central portion 35 that serves as the first radiating element, or main radiator, of the antenna 30. This first radiating element 31 communicates with an edge portion 36 which serves as an angled leg (not shown) that extends crosswise, or offset, from it down to an attachment point on a circuit board 14 of the telephone 10. In FIG. 2, this leg portion extends into the plane of the paper. This angled leg portion 36 may be formed integrally of the radiating element or may be formed as a separate piece that is electrically and mechanically connected thereto, such as by soldering. This leg portion 36 serves as a feed line for the entire antenna and is connected to feed circuits on the circuit board of the device.

A second leg portion 37 is provided and it also is angled with respect to the radiating elements 31-33. This leg portion is electronically connected to a ground plane of the telephone 10, which can be a separate component, or it can be formed on one of the circuit boards 14. The conductive portions of the antenna 30 include a second, or branch, radiating element 32 of the antenna which is shown as having a general L-shape and which extends around a portion of the first radiating element 31 and it is separated therefrom by an intervening spacing, or first slot 38, which is also preferably L-shaped. A third radiating element 33 is also provided. It too, in the embodiment illustrated, has a general L-shape and it is spaced apart from the first radiating element 31 by an intervening space, or second slot 39. The first and second slots 32, 39 are shown as having the same extent in that there ends are aligned along an imaginary line “E” shown in FIG. 2. The ground leg 37 of the antenna 30 is formed with the third radiating element 33 and it is spaced apart from the feed leg 36 and is further disposed along a different edge than the feed leg 36. Similar to the feed leg, as mentioned above, the ground leg 37 extends at an angle to the third radiating element 33 and extends into the plane of the paper in FIG. 2. Where as the one slot 38 is generally composed of linear segments, the other slot 39 is composed of both linear and curvilinear segments.

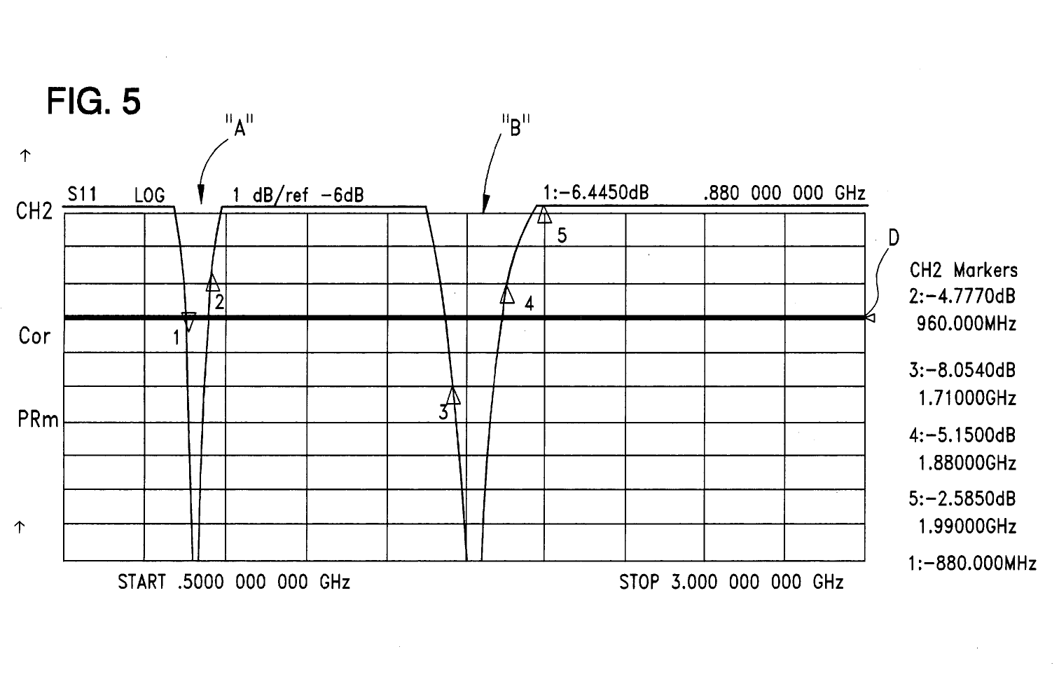

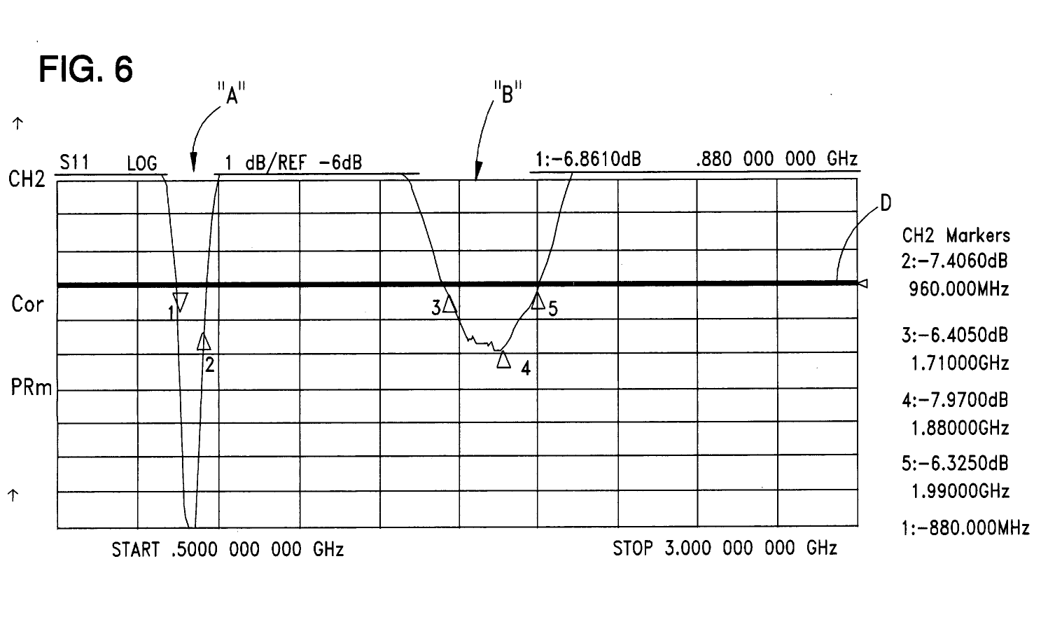

This style antenna will fit into the top portion of the internal cavity of the telephone housing 10 illustrated, and it supports the third radiating element 33 as a horizontal element that is attached to the ground pin, or leg 37. In this embodiment, the radiating element 38 drives the PCS frequency band, while the second radiating element 32 drives the GSM900 frequency band. The third radiating element improves the bandwidth of the antenna by driving the PCN frequency band of the antenna. This bandwidth aspect is best easily understood by referring to FIGS. 5 and 6.

FIG. 5 is a VSWR plot of the operation of the antenna 30 of FIG. 2, but without the third radiating element 33 in place. In this instance, as evidenced by the “markers” 1-5, it can be seen that two distinct operational frequency bands are defined, with the first band shown to the left of FIG. 5 and extending between markers 1 and 2 at frequencies of 880,000 MHz to 960,000 MHz, thereby covering the GSM900 band. The second operational frequency band in which the antenna operates is defined by markers 3 and 4 and can be seen, at the 6 dB level represented by the dark line D of FIG. 5, to cover the GSM 1800 band, from 1719 MHz to about 1880 MHz. This does not include the PCS or GSM 1900 MHz bands.

FIG. 6 illustrates a VSWR plot of the antenna 30 of FIGS. 2 and 4, with the third radiating element 33 in place. Two peaks are shown on the plot and the second peak, “B”, shown to the right of FIG. 6) is wider than the second peak, “B”, to the right of FIG. 5. This is because the third radiating element causes a third peak, or spike close to the second one and the two radiating elements cooperatively combine to form a single, wider peak, or spike. In FIG. 6, the first peak “A”, as defined by markers 1 and 2 provide an effective bandwidth from 880 to 960 MHz at 6 dB, while the second peak “B”, as defined by markers 3 and 5, provide an effective bandwidth from 1710 to 1990 MHz, thereby effectively encompassing both the GSM 1800 and 1900 bands (and the PCS band).

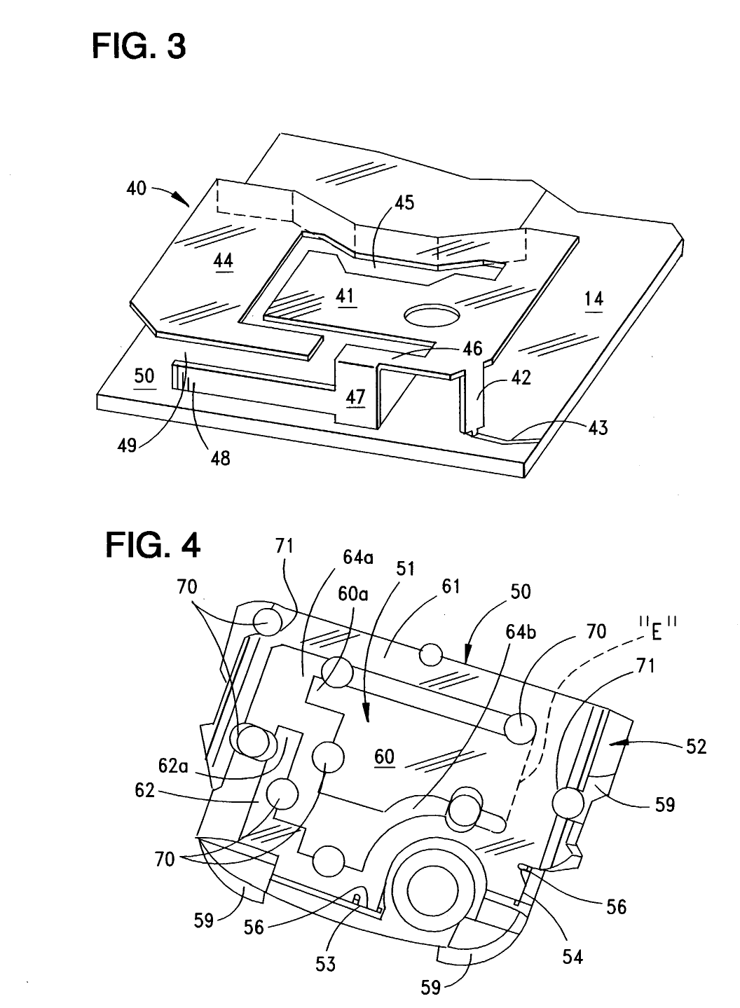

FIG. 3 illustrates another embodiment of a PIFA antenna 40 of the present invention with the antenna 40 being shown mounted to a circuit board 14. In this embodiment, the antenna is unsupported and is formed from planar elements. The antenna 40 has a first, or base radiator 41 that is in communication with a feed pin, or leg 42 that is connected to a feed circuit 43 of the circuit board 14. A second radiator 44 is provided and takes the form of a conductive branch that extends around a portion of the perimeter of the first radiator 41, shown in FIG. 3 as extending around portions of three sides of the perimeter of the first radiator 41. A slot 45 formed therein defines a space between the first and second radiators 41, 44.

An extension portion of the antenna serves to communicate a ground pin, or leg 47 with a first and second radiators. A third radiator 48 is provided and it extends horizontally spaced apart from the first and second radiators, 41, 44, as in the antenna 30 of FIG. 2, but it lies in a vertical plane rather than the common horizontal plane in which the first and second radiators 41, 44 lie. In this instance, the third radiator communicates directly with the ground pin 47 and extends in a direction between the two radiating elements and a ground plane 50 that is either formed on the surface of the circuit board 14 or formed as a layer of the circuit board. As illustrated, a second slot 49 is provided to separate the third radiating element 48 from the other radiating elements 41, 44 of the antenna.

FIG. 4 illustrates another embodiment of an antenna 50 of the present invention, which is a refinement of the basic shape shown in FIG. 2, and which primarily differs therefrom in that the antenna element 51 is supported on an insulative support base 52 that supports it in the housing cavity 12 above the various circuit boards and circuitry of the device 10. For the most part, the support member supports the antenna 50 over the portion 20 of the housing cavity 12. The antenna element 51 is fixed to the base 52 by a suitable means, such as the heat staking shown in FIG. 4, where the support member 50 is molded with a plurality of heat stakes 70 that are disposed in the slots that separate the various radiating elements of the antenna 50. As shown in the Figures, and as described below, the support member may include sidewalls 59 that space the support member base 52 off of a circuit board 20 in the device 10. The sidewalls 59 and the base cooperatively define a hollow cavity on the opposite side of the support member, that is behind the top surface that is shown in FIG. 4, into which components of the device may project from circuit boards or the like.

The antenna 50 includes a ground pin 53 and a feed pin 54 that are formed integrally with the conductive elements 51 and which extend downward through slots, or passages 56, that are formed in the insulative base 52. Preferably these feed and ground pins, or legs 53, 54 extend along sidewalls 82 of the support member base 52. The center portion of the antenna serves as a first radiator 60 along with its stub end 60a, while two other radiators 61, 62 extend around a portion of the perimeter of the first radiator 60 and are spaced apart therefrom by first and second slots 64a, 64b. These two slots 64a, 64b may have as illustrated the same extent into the body of the antenna and as such may be aligned with each other along the imaginary line “E” of FIG. 4. The base 52 may include stakes 70 formed therewith that rise up from the base 52 and which project adjacent to recesses 71 formed in the conductive elements 51 so that when heated and compressed, a mass of plastic is formed that engages the recesses to hold the conductive elements 51 in place on the base 52. The free end 62a of the third radiating element 62 projects between the free ends of the first and second radiating elements.

With the present invention, it is possible to provide a low-cost internal antenna that covers all the GSM frequency bands used in the world. The additional radiating element increases coupling among the radiating elements. Although the present invention has been described largely in terms of a separate antenna attached to a support, the antenna may be formed as an integral part of the substrate.

It will be understood that the invention may be embodied in other specific forms without departing from the spirit thereof. The present examples and embodiments, therefore, are to be considered in all respects as illustrative and not restrictive, and the invention is not to be limited to the details given herein.

What is claimed is:

1. An antenna capable of sending and receiving signals in three distinct frequency boards, comprising:
a base radiating element, a branch radiating element extending around a portion of a parameter of the base radiating element, the base and branch radiating elements being separated by a first intervening slot, a third radiating element partially extending along a portion of one said base and branch radiating elements and being separated therefrom by a second intervening slot, and
a feed element extending from said base radiating element for connecting said antenna to a feed circuit on a circuit board and a ground element extending from said antenna at an angle therefrom, the ground element being joined to the third radiating element.

2. The antenna of claim 1, wherein said base and branch radiating elements are planar elements.

3. The antenna of claim 1, wherein said base and branch radiating elements extend in a common horizontal plane.

4. The antenna of claim 3, wherein said third radiating element extends horizontally in a vertical plane at an angle to the common horizontal plane.

5. The antenna of claim 1, further including an insulative support member that supports said base, branch and third radiating elements thereon.

6. The antenna of claim 5, wherein said antenna is heat staked to the support member at locations within said first and second intervening slots.

7. The antenna of claim 5, wherein said support member includes a plurality of sidewalls and wherein said feed and ground elements extend at respective angles to said base and third radiating elements along the support member sidewalls.

8. The antenna of claim 7, wherein said antenna is supported on one side of said support member and wherein said sidewalls are disposed on an opposite side of said support member.

9. The antenna of claim 8, wherein said sidewalls cooperatively define a hollow cavity on said support member opposite side.

10. The antenna of claim 1, wherein said first intervening slot is L-shaped and said branch radiating element is L-shaped.

11. The antenna of claim 1, wherein said second intervening slot includes linear and curved portions.

12. The antenna of claim 1, wherein said branch radiating element extends along at least two different sides of a perimeter of said base radiating element.

13. The antenna of claim 5, wherein said support member includes a pair of passages formed therein which respectively receive said feed and ground legs therein.

14. An antenna for operating in three distinct frequency bands, comprising:
a first radiating element for operating in a first frequency band, a second radiating element for operating in a second frequency band, the second radiating element extending at least partially along a portion of outer edges of the first radiating element, the first and second radiating elements being separated by a intervening first slot, and a third radiating element for operating in a third frequency band, the third radiating element extending at least partially around a portion of the outer edges of one said first and second radiating elements, the third radiating element being separated therefrom by a second intervening slot;
feed and ground elements for respectively connecting said antenna to a feed circuit and a ground plane, the feed and ground elements extending from said antenna at an angle therefrom, said feed element extending from one of said first and second radiating elements and said ground element extending from said third radiating element; and,
a support member for supporting said antenna above a portion of an electronic device.

15. The antenna of claim 14, wherein said support member includes a base portion and a plurality of sidewalls and wherein said feed and ground elements extend along the support member sidewalls.

16. The antenna of claim 15, wherein said antenna is supported on one side of said support member and wherein said sidewalls are disposed on an opposite side of said support member.

17. The antenna of claim 16, wherein said sidewalls cooperatively define a hollow cavity on said support member opposite side.

18. The antenna of claim 14, wherein said three frequency bands include the PCS, PCN and GSM900 frequency bands.

19. The antenna of claim 14, wherein said first and second slots have free ends that are aligned with each other along an imaginary line.

20. The antenna of claim 14, wherein said first slot is formed from linear slot segments and said second slot is formed from both linear and curvilinear segments.
